(19) United States
(12) Patent Application Publication
(10) Pub. No.: US 2005/0034117 A1
(43) Pub. Date: Feb. 10, 2005

(54) Information processing apparatus and an information processing system

(75) Inventors: Hironori Emaru, Yokohama (JP); Toshiaki Hirata, Tokyo (JP); Takaichi Ishida, Yokohama (JP); Hideki Takano, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/887,723

(22) Filed: Jul. 9, 2004

(30) Foreign Application Priority Data
Aug. 6, 2003 (JP) 2003-206251

(51) Int. Cl. G06F 9/445

(52) U.S. Cl. 717/174

(57) ABSTRACT

An information processing apparatus includes an accepting unit for accepting inputs of identification information of a developed software program and parameter values used by the software program at a time of setup and an operation processing unit for generating identification information accepted by the input accepting unit and parameter configuration information used for defining the parameter values, thereby generating a parameter configuration table having the software identification information and the parameter values as information accompanied with the software and reducing a burden of setup of the system.

### INCORPORATION BY REFERENCE

The present application claims priority from Japanese application JP 2003-206251 filed on Aug. 6, 2003, the content of which is hereby incorporated by reference into this application.

### BACKGROUND OF THE INVENTION

The present invention relates to a technology of configuring parameter values used in executing a software when developing the software.

JP-A-5-73103 discloses an information processing apparatus that is aiding in configuring parameter values used for an information processing system. When a system administrator enters a parameter value, this information processing apparatus is operated to check validity between the parameter value and its associated parameter values according to the predetermined rules and then to output the checked result. From the checked result, the system administrator gets to know if the parameter value is to be modified with respect to the associated parameter values.

Further, JP-A-8-286959 discloses an information processing apparatus that determines parameter values used in a database system. This information processing apparatus determines a database system scale on the basis of component information (including a kind of SQL, a number of concurrent connections, and a table size) obtained after the database system is started and also determines the parameter values with reference to the table where the parameter values are registered according to each database system scale.

However, the information processing apparatus disclosed in the JP-A-5-73103 is required for the system administrator to enter the parameter values. In order to enter the proper values as the parameter, the system administrator is required to grasp the details of the system configuration. This thus causes a burden on the system administrator.

On the other hand, the information processing apparatus disclosed in the JP-A-8-286959 requires the component information obtained after the database system is started for the purpose of determining the parameter values. Hence, the system administrator is required to configure the parameter values to be used in installing the database system by another means. This also causes a burden on the system administrator.

### SUMMARY OF THE INVENTION

It is therefore an object of one embodiment of the present invention to lessen the burden on the system administrator when setting up the system.

According to an aspect of the invention, an information processing apparatus includes an input accepting block of accepting inputs of identification information of the produced software and of parameters used when the software is started, and an operation processing program block of generating identification information accepted by the input accepting unit and parameter configuration information for defining the parameter values.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic block diagram showing a development-used computer according to an embodiment of the present invention;

FIG. 2 is a conceptual view showing a data structure of a parameter configuration table according to an embodiment of the present invention;

FIG. 3 is a view showing an exemplary component of a GUI (Graphic User Interface) for producing the parameter configuration table according to an embodiment of the present invention;

FIG. 4 is a flowchart showing a process of producing the parameter configuration table to be executed by a parameter configuration module according to an embodiment of the present invention;

FIG. 5 is a schematic block diagram showing an information processing system according to an embodiment of the present invention;

FIG. 6 is a flowchart showing a process of starting a software with parameters entered therein to be executed by the control module program shown in FIG. 5;

FIG. 7 is a block diagram showing an information processing system according to an embodiment of the present invention;

FIG. 8 is a flowchart showing a process of starting a software with parameters entered therein to be executed by the control module program shown in FIG. 7;

FIG. 9 is a view showing an exemplary component of a GUI for arranging the parameter configuration table according to an embodiment of the present invention;

FIG. 10 is a schematic block diagram showing a test-used computer according to an embodiment of the present invention;

FIG. 11 is a flowchart showing a process of producing a parameter configuration table to be executed by the module program for producing the parameter configuration table shown in FIG. 10;

FIG. 12 is a table conceptually showing a data structure of a performance/parameter mapping table according to an embodiment of the present invention;

FIG. 13 is a block diagram showing an information processing system according to an embodiment of the present invention; and

FIG. 14 is a flowchart showing a process to be executed by the managing module program shown in FIG. 13.

### DETAILED DESCRIPTION OF THE EMBODIMENTS

Hereafter, the embodiments of the present invention will be described with reference to the appended drawings.

At first, the description will be oriented to the arrangement of the information processing apparatus (development-used computer) for producing a software according to the embodiment of the present invention.

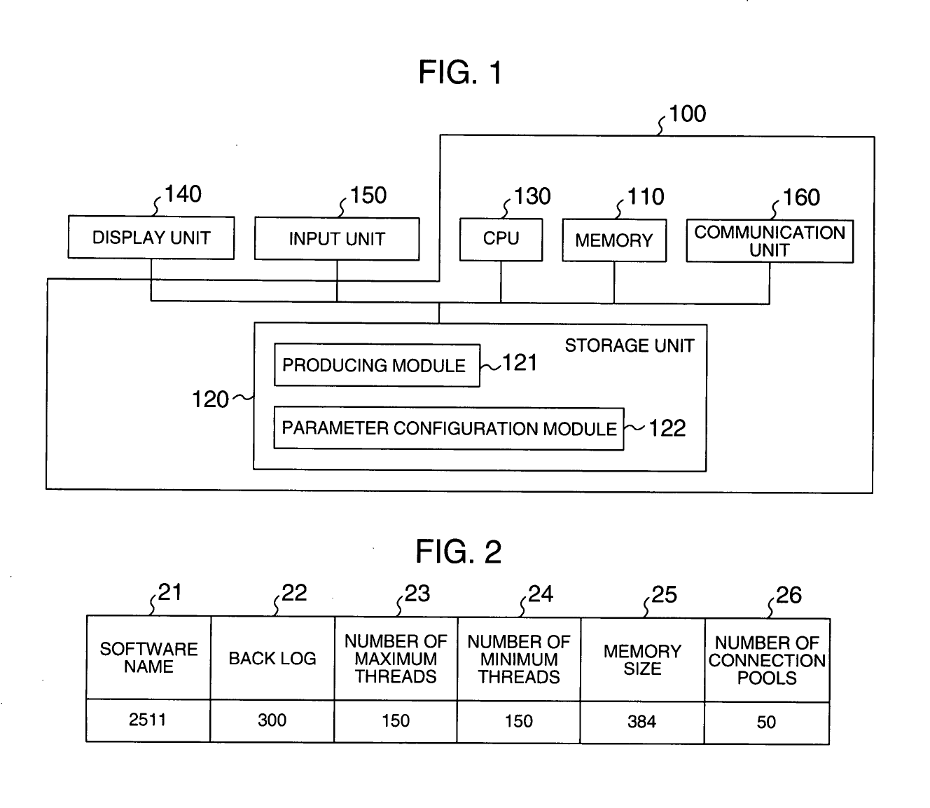

FIG. 1 is a schematic block diagram showing the development-used computer according to the embodiment of the present invention.

A reference number 100 denotes a development-used computer, which includes a storage unit 120 for storing various kinds of information (programs and data) required for producing a software and configuring parameter values, a memory 110, a CPU 130 for executing programs being loaded from the storage unit 120 to the memory 110, a communication unit 160 being connected with a network, and a bus for connecting those components with one another. Further, this software development-used computer 100 is connected with an input unit (keyboard, mouse and so forth) for accepting data input from a software engineer and a display unit 140 for displaying various kinds of information of the GUI or the like to be discussed below.

The storage unit 120 is installed with a development-used module program 121 for aiding in developing a software and a parameter configuration module program 122 for aiding in producing a parameter configuration table accompanied with the software developed by the module program 121. These programs 121 and 122 are distributed in the state recorded on a recording medium (CD-ROM or the like) and installed in the storage unit through the drive. Or, these programs may be delivered from another information processing apparatus and then installed in the storage unit.

The development-used module program 121 is executed to display, on the display unit 140, a development-used screen for aiding in producing the software and automatically develop the software based on the data entered on the development-used screen. The software developed thereby is stored in the storage unit 120. The software developed by such a development-used, module may be a component (Servlet, JSP, Enterprise Beam or the like) for composing a Web application server or an enterprise application for packaging these components.

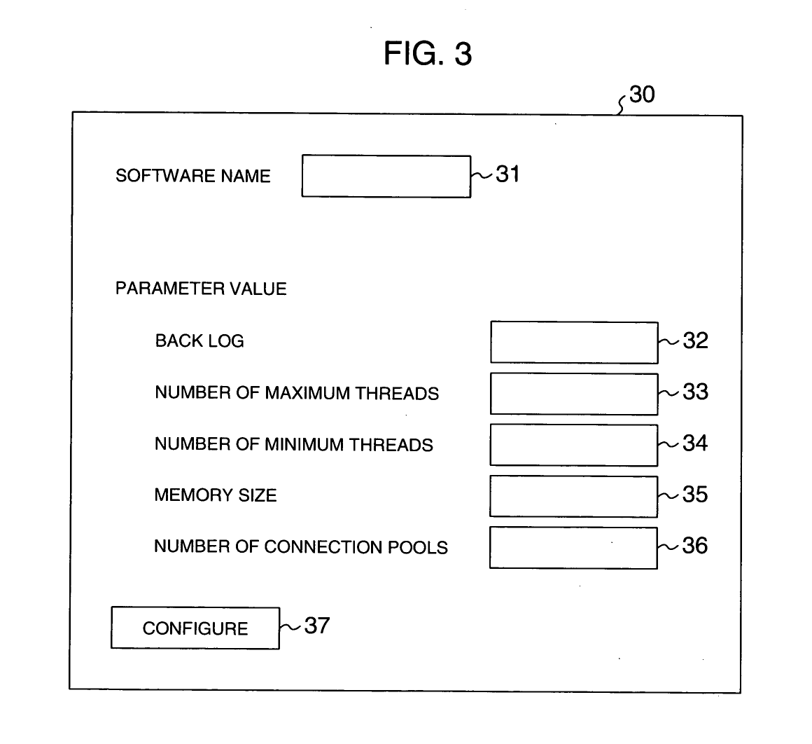

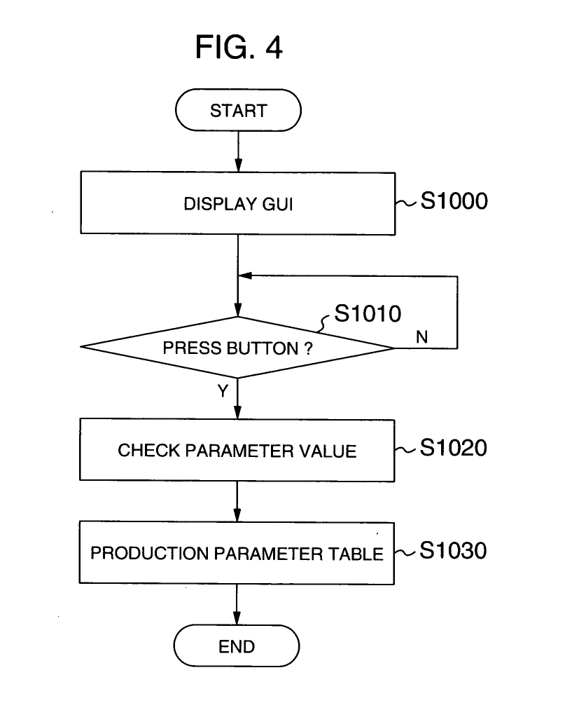

On the other hand, the parameter configuration module program 122 is executed to display on the display unit 140 the GUI 30 for producing the parameter configuration table shown in FIG. 3, for the purpose of aiding in producing the parameter configuration table. On this parameter configuration table producing GUI 30 are disposed a filed 31 for accepting an input of identification information (including a software name that uniquely identifies the software), fields 32 to 36 for accepting inputs of parameter values to be used by the software specified by the data inputted on the field 31, and a button 37 for accepting an indication of producing the parameter configuration table. Herein, as concrete parameters on the parameter configuration table producing GUI 30, a back log, number of maximum threads, number of minimum threads, a memory size, and number of connection pools may be referred. However, the parameters on the GUI 30 that are to be configured with the parameter values are not necessarily required to be defined as these five parameters.

When the software engineer enters proper data (software names and parameter values) in the fields 31 to 36 located on the GUI 30 and clicks the button 37 with the input unit 150, the parameter configuration module program 122 is started to create the parameter configuration table from the data entered in the fields 31 to 36.

FIG. 2 shows a data structure of the parameter configuration table produced by the parameter configuration module program 122. The parameter configuration table includes a field 21 for storing a software name entered in the field 31 and fields 22 to 26 where the parameter values entered in the fields 32 to 36 are stored. On the parameter configuration table shown in FIG. 2 is described an example of data for the explanation's convenience. However, the data with the same format as the data in the parameter configuration table shown in FIG. 2 are not necessarily required on the data table produced by the parameter configuration module program 122. For example, in FIG. 2, the numeric value is used as the software name. In actual, however, not the numeric value but a character string may be used as the software name. Further, the parameter value is attached with a unit like MB (Mega Bytes).

In turn, the description will be oriented to the process of producing the parameter configuration table. This process is realized by executing the parameter configuration module program 122.

When the software engineer starts the parameter configuration module program 122 on the development-used computer 100, the parameter configuration module program 122 is caused to execute the following process.

The parameter configuration module program 122 is executed to display on the display unit 140 the GUI 30 for producing the parameter configuration table (S1000). Herein, with the input unit 150, the software engineer is required to enter a name of the software produced by the engineer and parameter values to be used in starting the software on the fields 31 to 36 located on the GUI 30. Afterwards, also with the input unit 150, the software engineer presses the button 37 located on the GUI 30 (S10101), the parameter configuration module program 122 is executed to check if the data entered in the fields 32 to 36 of the GUI 30 are mismatched on the basis of the conditional expression defined by the software engineer (S1020). For example, if the memory size m used by one thread is defined, the relation between the memory size M and S number of threads to be used by the software is required to meet the conditional expression of M>S×m. In such a case, the parameter configuration module program 122 is executed to check if the parameter values of the memory size and the thread configured on the GUI 30 fulfill the conditional expression M>S×m.

As a result, if the input data of the fields 32 to 36 located on the GUI 30 contain some contradiction, the parameter configuration module program 122 is executed to display on the display unit a message for prompting the engineer to reenter the new parameter values in place of the mismatched parameter values.

On the other hand, if the data entered on the fields 32 to 36 located on the GUI 30 do not contain any contradiction, the parameter configuration module program 122 is executed to input the data entered on the fields 32 to 36 of the GUI 30 in the parameter configuration table (S1030). For example, when “2511”, “300”, “150”, “150”, “384”, and “50” are entered in the fields 31 to 36 of the GUI 30, as shown in FIG. 2, the parameter configuration table is produced so that “2511” is put as the software name, “300” is put as the back log, “150” is put as the number of maximum threads, “150” is put as the number of minimum threads, “384” is put as the memory size, and “50” is put as the number of connection pools.

Afterwards, the parameter configuration module program 122 is executed to describe the parameter configuration table produced at this time in a file with a proper name and then to store the table in the storage unit 120.

As described above, this process of producing the parameter configuration table allows the software engineer to determine the parameter values to be used in executing the software developed by the engineer and to accompany the software with the parameter configuration table including those parameter values. With the general Web system having the application server and the database server as an example, if it is predicted that lots of works that are required to execute the reference process are generated, that is, the server's load is low, the software engineer may try to improve a throughput by specifying a bit larger value as the number of maximum threads. On the other hand, if it is predicted that lots of works that are required to execute the update process are generated, that is, the database server's load is high, the software engineer may prevent the database server from being put into an excessive load state by specifying a smaller value as the number of connection pools. As mentioned above, the software engineer may specify a proper parameter value according to the way of use of the system. This makes it possible to keep the system performance.

Further, only if the parameter values entered by the software engineer do not contain any contradiction, the parameter configuration table is produced. This allows the mismatched parameter values to be included in the parameter configuration table.

Hence, the system administrator who has installed the software causes the software to be executed in the proper environment realized by the proper parameter values determined by the software engineer who grasps the software characteristics most without any troublesome work of grasping the software characteristics and then executing the special settings. This thus allows the burden of the system administrator to be lessened when setting up the system.

The foregoing arrangement includes the development-used module program 121 and the parameter configuration module program 122 implemented on one computer. In place, both of these programs may be implemented in respective computers.

By the way, in general, the produced software is tested (checked) with respect to the predetermined items such as whether or not bugs exist and specified performance is met. In the foregoing process, the software engineer specifies each parameter value. In place, it is arranged that the parameter values may be automatically determined on the checked result. Hereafter, this automatic determination will be described.

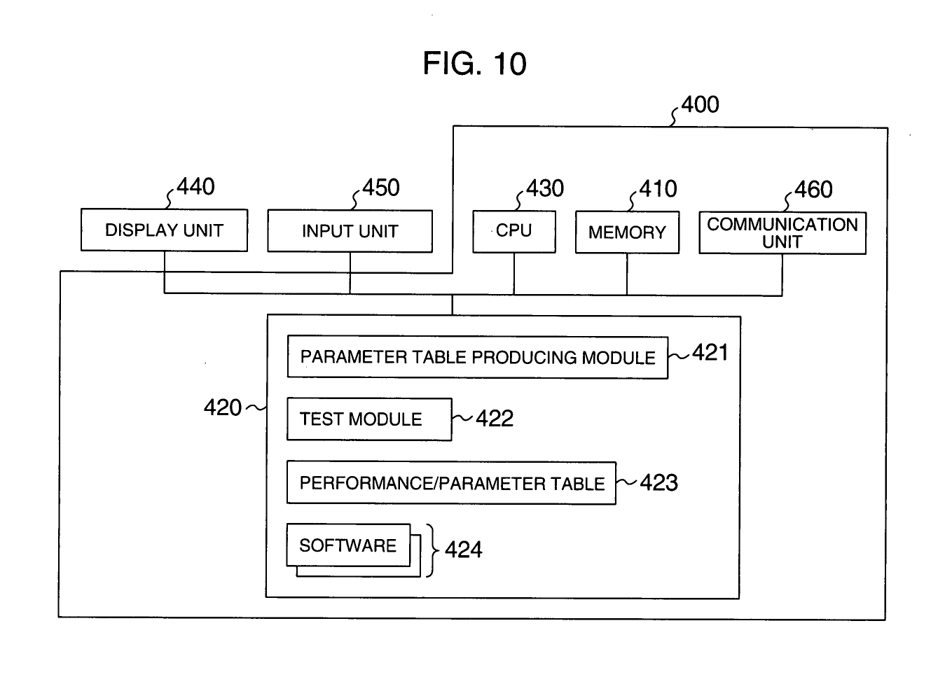

FIG. 10 is a schematic block diagram showing an information processing apparatus (test computer) that produces the parameter configuration table by testing the software.

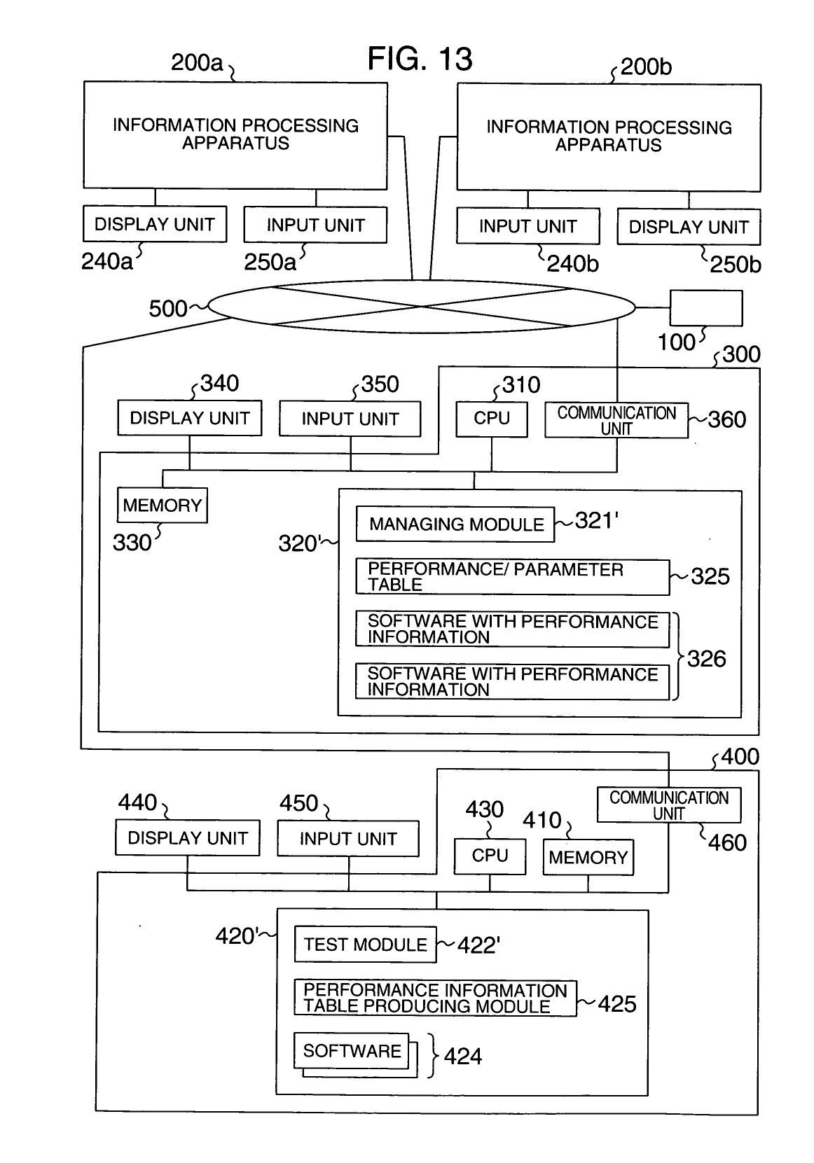

The test-used computer 400 includes a storage unit 420 for storing a software program 424 produced by the development-used computer shown in FIG. 1 and various kinds of information required for a software test or the like, a memory 410, a CPU 430 for executing the program loaded from the storage unit 420 to the memory 410, a communication unit 460 for controlling communications through a network 500 (see FIG. 13), and a bus for connecting those components with one another. Further, this test-used computer 400 is connected with the input unit (keyboard, mouse or the like) that accepts data input from a person who executes the test (simply referred to as a tester) and a display unit 440 that displays various kinds of information including the tested results.

The storage unit 420 stores a test module program 422 for executing the test of the software 424, a module program 421 for producing the parameter configuration table of the software, and a performance/parameter mapping table 423 to be referenced by the module program 421. These program and tables 423 are distributed in the state of being recorded in a recording medium (CD-ROM or the like) and then installed in the storage unit through a drive. Instead, they may be delivered from another information processing apparatus through a network and then installed into the storage unit.

When the target software to be tested is specified in the software 424 stored in the storage unit 420 by a tester, the test module program 422 is started to execute the test of the target software. If the software passes the test, the test module program 422 starts the parameter producing module program 421. At a time, the test module program 422 is operated to pass to the parameter producing module program 421 the information predetermined as the performance criterion of the software (that is, performance information) from the tested result together with the identification information of the software. Herein, the performance information includes a memory size, a response time, and the number of threads. In actual, the performance information may be determined according to the tested contents of the test module program 422.

Further, the parameter creating module program 421 is operated to produce the parameter configuration table of the software based on the information derived from the test module program 422 and the performance/parameter mapping table 423. The data structure of the parameter configuration table produced at this time is likewise to that of the foregoing case (see FIG. 2).

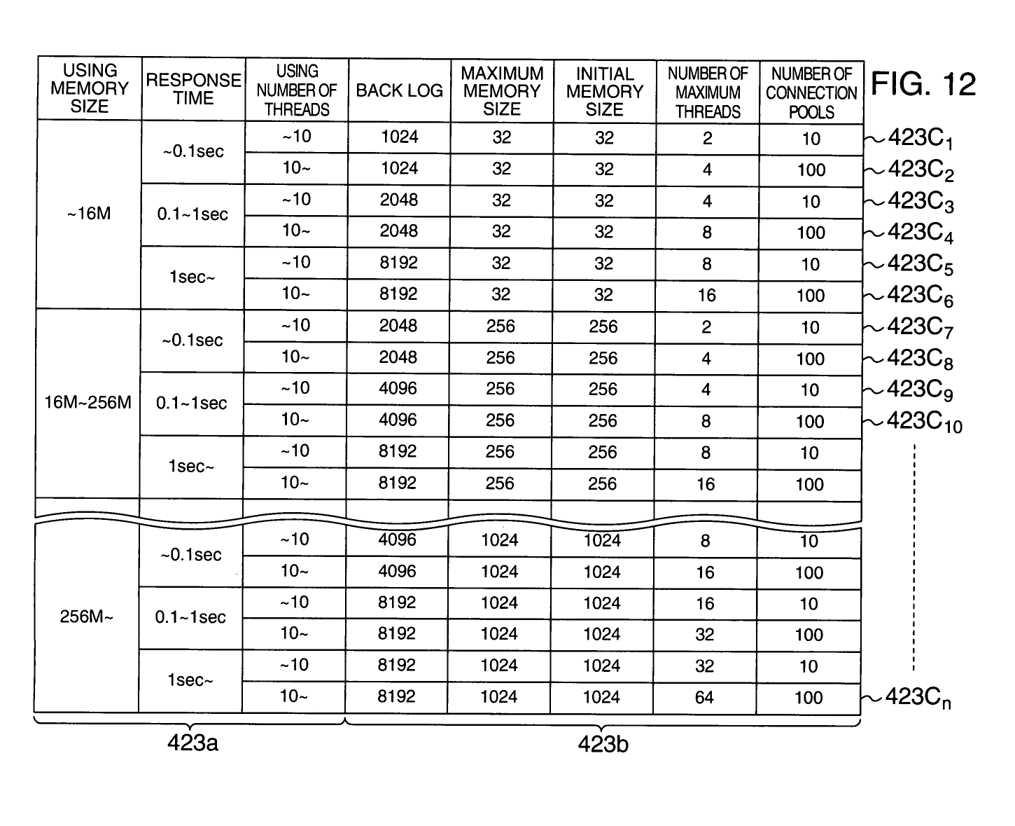

As shown in FIG. 12, the performance/parameter mapping table 423 stores the correspondence informations 423c₁ to 423cₙ between the performance condition set 423a including the conditions (herein, the numerical value range) determined about plural pieces of performance information obtained by the tested result and the parameter value set 423b that causes the system performance to be totally optimized by using the parameter value set in the software that indicates the performance information meeting each condition of the performance condition set. Herein, as the parameter values that compose the parameter value set, five parameters are referred. That is, those parameters are a back log, number of maximum threads, number of minimum threads, a memory size, and number of connection pools. In actual, the types of parameter values composing the parameter value set may be specified according to the types of parameter values included in the parameter configuration table. This kind of table is produced on the basis on the result of the preliminary experiment and the analogical reasoning derived from the analogous system.

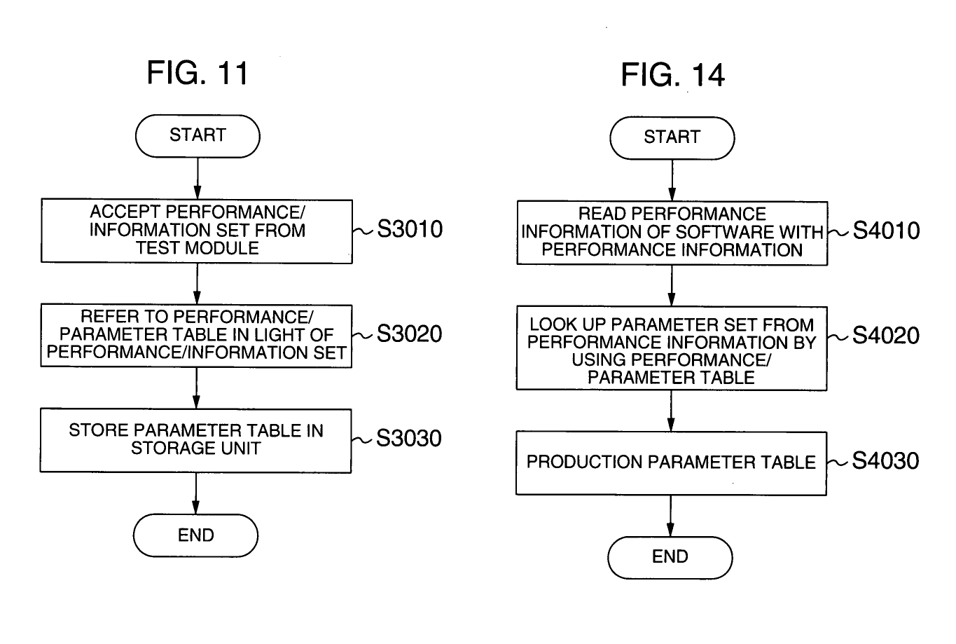

In turn, the description will be oriented to the process of producing the parameter configuration table realized by executing the parameter configuration table module program 422 with reference to FIG. 11.

When the module program 422 is inputted with the identification information of the target software to be tested and the predetermined performance information (the using memory size, the response time, and the using the number of threads) of the identification information of the target software derived from the tested result from the test module program 422 (S3010), the parameter configuration table producing module program 422 is operated to retrieve a row having the performance condition set corresponding with the performance information inputted thereto from the performance/parameter configuration table 423 (S3020). When only partial performance information of the using memory size, the response time, and the using number of threads is passed to the parameter configuration table producing module program 422, the module program 422 may be arranged to retrieve the row with the partial performance information as a key.

If the corresponding row is obtained as the retrieved result, the parameter configuration table producing module program 422 produces the parameter configuration table including the parameter value set contained in the row and the software identification information passed from the test module program 422 and then stores the parameter configuration table in the storage unit 420 (S3030).

As described above, if the parameter configuration table is automatically produced on the tested result of the software, it may save the troublesome work having been burdened to the software engineer.

In turn, the description will be oriented to the executing environment of the software produced by the development-used computer 100 shown in FIG. 1 or tested by the test-used computer shown in FIG. 10. Hereafter, the set of the software and the parameter configuration table produced by this software is called the parameter-attached software.

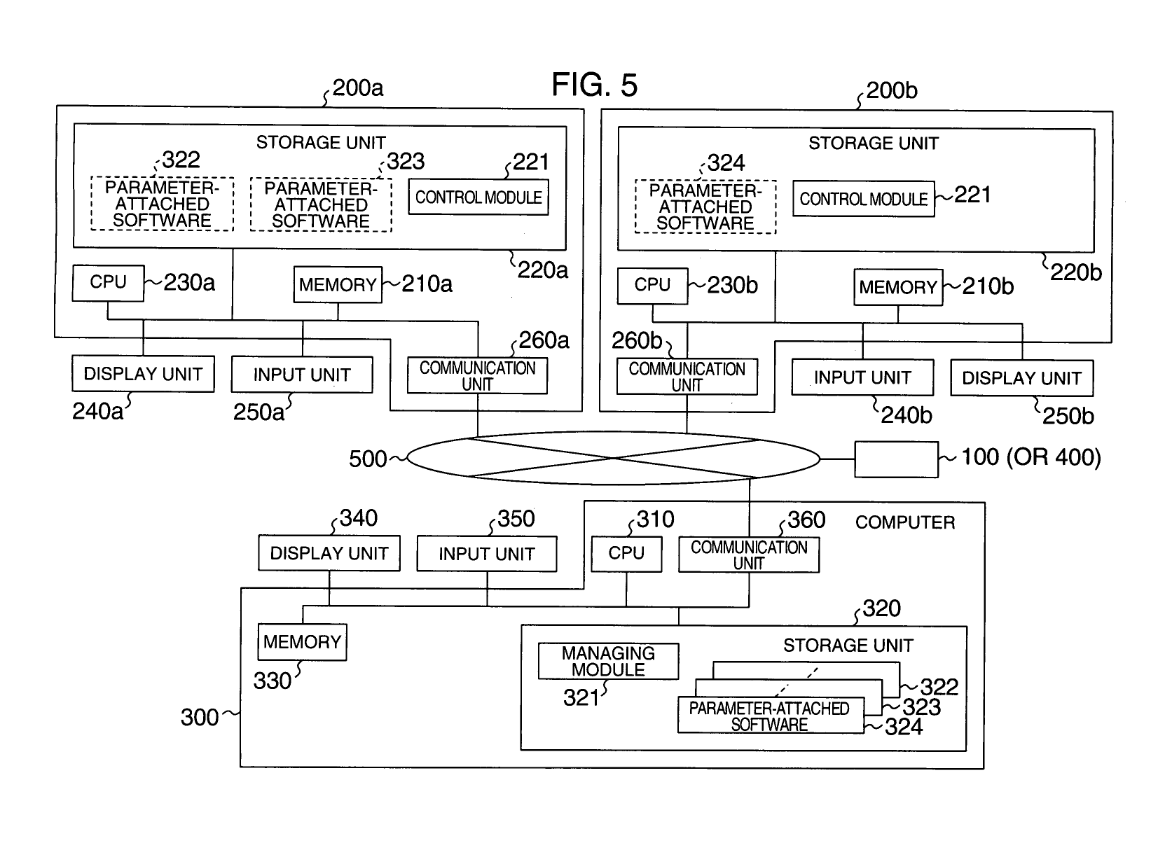

FIG. 5 shows a schematic block diagram of the computer system that executes the software produced by the development-used computer 100 shown in FIG. 1 and the software tested by the test computer shown in FIG. 10.

This computer system includes a plurality of (herein, three) information processing apparatuses 300, 200a, 200b, the foregoing development-used computer 100 (or the foregoing test-used computer 400), and a network 500 like a LAN for connecting those components with each other.

Of the three information processing apparatuses 300, 200a, and 200b, at least one information processing apparatus 300 has a role of managing the parameter-attached software programs 322 to 324. This managing computer 300 includes a storage unit 320 for storing the parameter-attached software programs 322 to 324 and various kinds of information required for managing these parameter-attached software program, a memory 330, a CPU 310 for executing the program to be loaded from the storage unit to the memory, a communication unit 360 for controlling communications through a network 500, and a bus for connecting those components with one another. Further, this managing computer 300 is connected with the input unit (keyboard, mouse or the like) 350 and the display unit 340 for displaying various kinds of information.

The storage unit 320 included in this managing computer 300 stores the parameter-attached software programs 322 to 324 and the managing module program 321. The managing module program 321 is distributed in the state of being recorded in the storage medium (CD-ROM or the like) and then installed in the storage unit through a drive. In place, the program 321 may be delivered from another information processing apparatus through a network and then installed to the storage unit. This holds true to the managing module program of the computer system to be referred below to as another example. Further, the parameter-attached software programs 322 to 324 may be transferred from the storage unit of the development-used computer 100 or the storage unit of the test-used computer 400 through a network. Or, these programs 322 to 324 may be read from the storage medium (CD-ROM or the like) having stored the parameter-attached software programs stored in the storage medium of the development-used computer 100 or the storage unit of the test-used computer 400. The parameter configuration table of each of the parameter-attached software programs 322 to 324 is not necessarily required to be supplied together with the software program itself. The table may be supplied to the managing computer 300 apart from the parameter-attached software program. These matters hold true to the parameter-attached software program of the computer system to be referred below to as another example.

Then, this managing computer 300 executes the managing module program 321 in response to an indication given from a administrator through the input unit 350. The managing module program 321 operates to read out the parameter-attached software program indicated by the administrator (that is, the software program with a name indicated by the administrator and the parameter configuration table with its name) of the parameter-attached software programs 322 to 324 stored in the storage unit 320 and then transfer the read parameter-attached software program to the information processing apparatus indicated by the administrator, the apparatus being located on the network 500.

On the other hand, the other two information processing apparatuses 200a and 200b are of management-objected computers that execute the parameter-attached software program. These managed computers 200a and 200b include storage units 220a, 220b for storing programs and data, memories 210a, 210b, CPUs 230a, 230b for executing the program loaded from the storage unit to the memory, communication units 260a, 260b for controlling communications through a network 500, and buses for connecting those components, respectively. Further, These managed computers 200a and 200b are connected with the input units (keyboard or mouse) 250a, 250b and display units 240a, 240b for displaying various kinds of information, respectively.

Each storage unit 220a or 220b of the managed computer 200a or 200b stores a control module program 221 and the parameter-attached software program transferred from the managing computer. The control module program is distributed in the state of being recorded on a recording medium (CD-ROM or the like) and then installed to the storage unit through a drive. As another way, it may be delivered from another information processing apparatus through a network and then installed to the storage unit. These matters hold true to the control module program of the computer system to be referred below as another example.

Herein, the two managed computers are indicated. In actual, however, the number of the managed computers is not limited to two. This holds true to another computer system to be described below.

In turn, the description will be oriented to the process of starting the parameter-attached software program to be realized by the execution of the control module program.

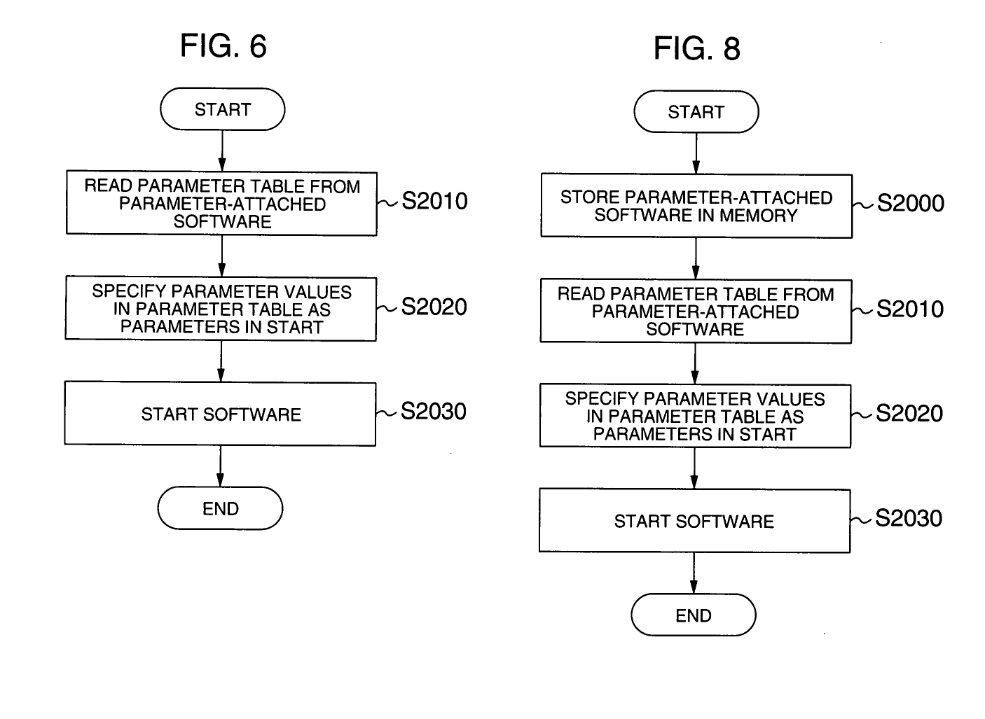

FIG. 6 is a flowchart showing the process of starting the parameter-attached software program.

The user enters a start command of the control module program 221 with the input unit 350b. In the managed computer (herein, 200b), the control module program 221 is loaded from the storage unit to the memory and then executed. Then, the following process will be executed.

When the control module program 221 accepts the name of the software specified by the user, the module program 221 is operated to read the parameter configuration table including the software name out of the parameter-attached software programs stored in the storage unit (S2010). Then, the control module program 221 is operated to specify the parameter values included in this parameter configuration table as the parameters to be used in starting the software (S2020). Further, the control module program 221 is also operated to start the software program of the name specified by the user with the parameter specified in the step 2020 as an argument or the like (S2030).

In the foregoing process of starting the parameter-attached software, when starting the software, the administrator may use the parameter value in the parameter configuration table which is produced by himself by the software developer. Hence, the user may execute the software program with the parameter value intended by the engineer who grasps the software characteristics most merely by starting the control module program.

In the foregoing process, it is arranged that the parameter-attached software is stored in the storage unit 320 of the managing computer 300 and then is transferred to the storage units 220a and 220b of the managed computers 200a and 200b. In place, the parameter-attached software may be directly transferred from the storage unit 120 of the development-used computer 100 or the storage unit 420 of the test-used computer 400 to the storage unit 220a or 220b of the managed computers 200a or 200b.

The execution environment of the parameter-attached software has been described along the embodiment. However, the execution environment thereof is not necessarily required to be the same as the foregoing environment. Hereafter, the other environment will be described.

The managed computers 200a or 200b of the computer system shown in FIG. 5 is arranged to store the parameter-attached software transferred from the managing computer 300 in the storage unit 220a or 220b. In actual, however, the parameter-attached software transferred from the managing computer 300 may be directly loaded from the communication unit 260a or 260b into the memory 210a or 210b without being stored in the storage unit 220a or 220b. In this case, the computer system is the same as the computer system shown in FIG. 5 except the following two respects.

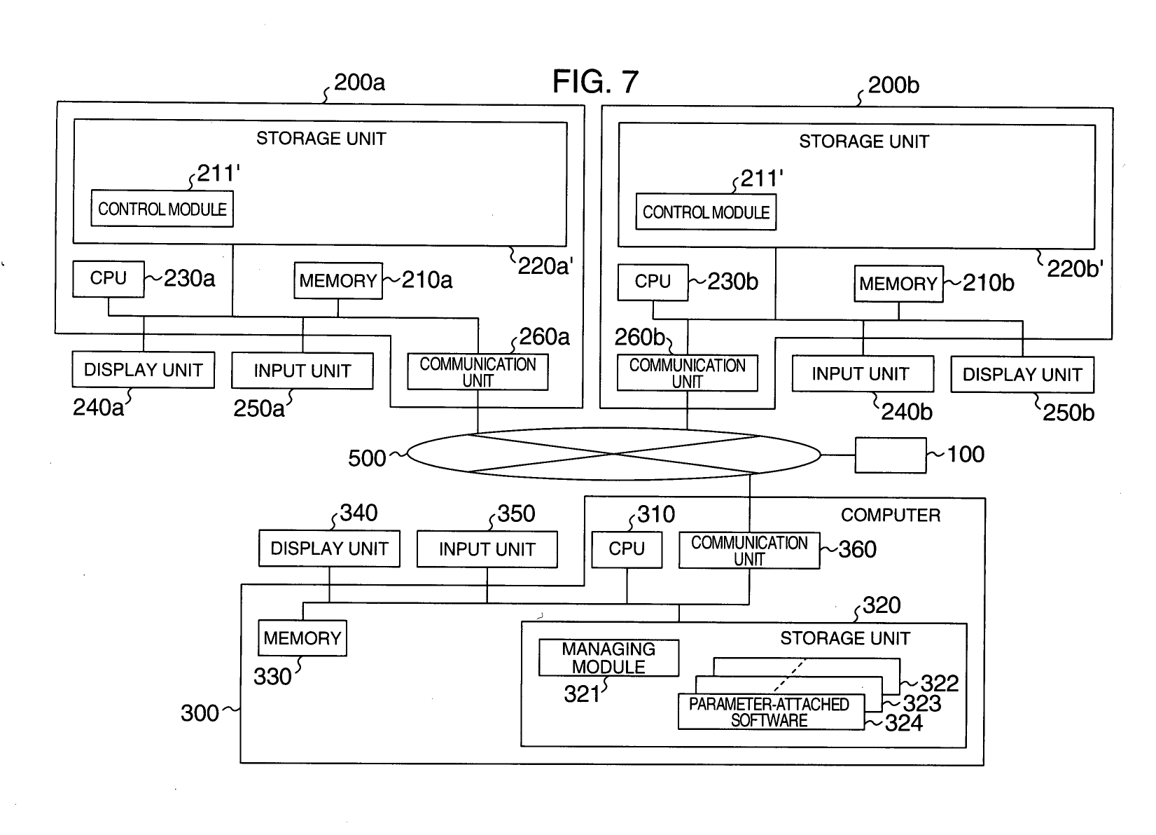

First, the parameter-attached software is stored in the storage unit 220a or 220b of the managed computer 220a or 220b of FIG. 5, while in that case, the parameter-attached software is not stored in the storage unit 220a′ or 200b′ of the managed computer 220a or 220b as shown in FIG. 7.

Second, the control module program 221 stored on the managed computer of FIG. 5 is started in response to the command given from the user and then executes the process of S2010 to S2030 with respect to the parameter-attached software stored in the storage unit as shown in FIG. 6. On the other hand, in that case, as shown in FIG. 8, when the parameter-attached software from the managing computer 300 is received in the communication unit, the control module program 211′ stored on the managed computer is operated to load the parameter-attached software from the communication unit to the memory (S2000) and then executes the process of S2010 to S2030 with respect to the parameter-attached software stored in the memory.

Further, in the computer system of FIG. 5, it is arranged that the software with the parameter configuration table produced by the development-used computer 100 or the test-used computer 400 is stored in the storage unit 320 of the managing computer 300. However, this arrangement is not necessarily required. For example, it is arranged that the managing computer 300 produces the parameter configuration table based on the tested result of the software program and accompanies the software with the parameter configuration table.

As shown in FIG. 13, the computer system in this case includes the similar managed computers 200a and 200b as the computers shown in FIGS. 5 and 7, the same development-used computer 100 as the computer shown in FIG. 1, the managing computer 300, the test-used computer 400, and the network 500 for connecting those components with one another.

The test-used computer 400 and the managing computer 300 included in the computer system in this case are the same as the foregoing test-used computer 400 and managing computer 300 except the following respects.

The test-used computer 400 in this case is different from the test-used computer 400 shown in FIG. 10 merely in the following respect.

First, in this case, the storage unit 420′ of the test-used computer 400 stores the performance information table creating module program 425 in place of the performance/parameter mapping table 423 (see FIG. 10) and the parameter configuration table producing module program 421 (see FIG. 10). This performance information table producing module program 425 may be delivered in the state of being recorded on the storage medium (CD-ROM or the like) and then installed to the storage unit through a drive. Or, the module program 425 may be delivered from another information processing apparatus through a network and then installed to the storage unit.

Second, when the software passes the test, the test module program 422′ in this case is operated to start the performance information table producing module program 425 and then passes the identification information of the software and the predetermined performance information of the tested result to the performance information table producing module program 425. When the module program 425 is given the identification information of the software and the predetermined information of the tested result by the test module program 422′, the module program 425 produces the performance information table where these information items correspond with the information names. A set of this performance information table and the corresponding software program of the software 424 stored in the storage unit 420′ is transferred to the managing computer 300 as the software program 326 with the performance information.

Further, in this case, the managing computer 300 is different from the managing computer 300 shown in FIG. 5 or 7 merely in the following respect.

First, in this case, the storage unit 320′ of the managing computer 300 stores the software program 326 with the performance information from the test-used computer 400 in place of the parameter-attached software programs 322 to 324. These software programs with performance information 326 may be transferred from the test-used computer 400 through the network 500. Or, it may be read from the storage medium (CD-ROM or the like) having stored the software with the performance information tested by the test-used computer 400.

Second, also in this case, the storage unit 320′ of the managing computer 300 stores the performance/parameter mapping table 325 having the same data structure as the performance/parameter configuration table shown in FIG. 12.

Third, also in this case, the managing module program 321′ is started in response to an indication given by the administrator and then executes the following process as shown in FIG. 14.

The managing module program 321′ is operated to read the performance information table of the software with the performance information indicated by the administrator of the software 326 with the performance information stored in the storage unit 320′ (S4010). Afterwards, the managing module program 321′ is operated to retrieve in the performance/parameter mapping table 325 a row wherein each performance information item included in the performance information table has the concerned performance condition set. If the concerned row is obtained as the retrieved result, the managing module program 321′ creates the parameter configuration table including the parameter value set included in the row and the software identification information included in the performance information table (S4030). Then, a set of the parameter configuration table produced in this process and the corresponding software with performance information is transferred to the managed computer indicated by the administrator as the parameter-attached software.

By the way, when developing the software, though the software characteristic may be grasped by the engineer, the scale of the system where the software is run and the hardware where the software is run cannot be completely grasped by the engineer. Further, when developing the software, whether or not there exists any system to be properly combined with the software and what system it is if any cannot be often grasped by the engineer. Hence, as described below, the computer system shown in FIGS. 5 and 7 may be arranged so that the parameter values specified by the software engineer and automatically specified by the test-used computer may be grasped by the system administrator or the like.

In this case, the following function of aiding in the work of adjusting the parameter of the system administrator is added to the managing module program 321′ stored in the managing computer 300.

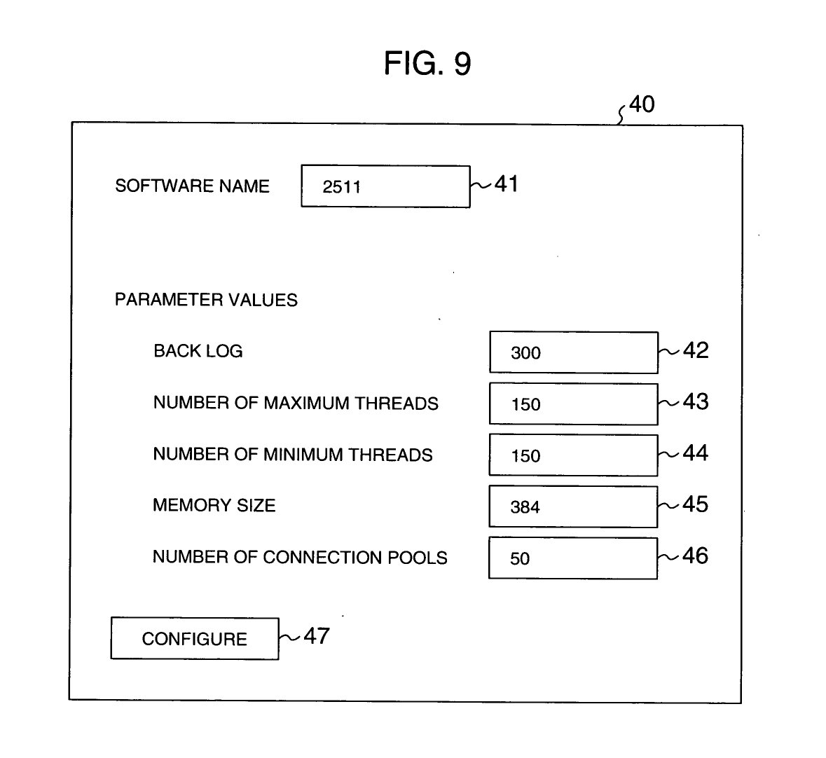

When the managing module program 321′ accepts one of the parameter-attached software programs stored in the storage unit 320′ from the system administrator, the parameter adjusting GUI 40 shown in FIG. 9 is displayed on the display unit 340. On this parameter adjusting GUI 40 has an non-editable field 41 (see FIG. 9) where the name of the selected parameter-attached software is displayed, editable fields 42 to 46 (see FIG. 9) where the parameter values included in the parameter configuration table of the selected parameter-attached software are displayed, and a button 47 that accepts an indication of adjusting the parameter configuration table. The system administrator edits the parameter values appearing on the fields 42 to 46 of the parameter adjusting GUI 40 as necessary with the input unit 350 and then clicks the button 47. Then, the managing module program 321′ is operated to rewrite the parameter values included in the parameter configuration table of the parameter-attached software selected by the system administrator to the parameter values appearing in the fields 42 to 46 of the parameter adjusting GUI 40.

The foregoing operation makes it possible for the system administrator to specify the parameter values more fine. Concretely, the operation causes the system administrator to specify the parameter values more properly on the basis of the parameter values specified by the software engineer as considering the system scale, the hardware specification, and the system arrangement.

Herein, the control module program is started in response to an indication given from the user. In place, when the parameter-attached software is transferred from the managing computer, the control module program may be automatically started. Or, after the parameter-attached software is transferred, the managing module program 321′ of the managing computer 300 may be operated to transmit the execution request of that parameter-attached software to a destination managed computer and then to start the process of starting the parameter-attached software in response to the execution request.

The aforementioned computer systems may be used as the execution environment of the package software program. For example, if the format of the parameter configuration table conforms to some specifications, the software supplier enables to produce the parameter configuration table accompanied with the software and the control module program for interpreting the parameter configuration table and starting the software program on the basis of the public information. As mentioned above, if the proper parameter configuration table and the control module program are set to the commercially available software program, the system administrator enables to execute the software program with the proper parameter values if the administrator does not know the details of the software program. This allows the burden of the system administrator to be lessened when setting up the computer system.

It should be further understood by those skilled in the art that although the foregoing description has been made on embodiments of the invention, the invention is not limited thereto and various changes and modifications may be made without departing from the spirit of the invention and the scope of the appended claims.

1. An information processing apparatus comprising:
an input accepting unit accepting inputs of identification information of a developed software program and parameter values used by said software program at a time of setup; and
operation processing means generating said identification information accepted by said input accepting unit and parameter configuration information used for defining said parameter values.

2. An information processing apparatus according to claim 1, wherein said operation processing means checks if said parameter values accepted by said input accepting unit fulfill a predetermined condition and, if fulfill, generates said parameter configuration information.

3. A storage medium having stored one or more programs to be executed by an information processing apparatus and being readable by said information processing apparatus, said programs causing said information processing apparatus to be functioned as an input accepting unit for accepting inputs of identification information of a developed software program and of parameter values used by said software program at a time of setup; and
operation processing means generating said identification information accepted by said input accepting means and parameter configuration information used for defining said parameter values.

4. A storage medium according to claim 3, wherein said operation processing means checks if said parameter values accepted by said input accepting unit fulfill a predetermined condition, and, if fulfill, generates said parameter configuration information.

5. An information processing apparatus comprising:
a storage unit storing a plurality of correspondence information items between parameter values and condition information for representing an applicable condition of said parameter values; and
operation processing means reading said parameter values, obtained by a test of a developed software program and corresponded with condition information that fulfills with performance information for representing performance of said developed software program from said storage unit and generating parameter configuration information used for defining said parameter values and identification of said software program.

6. A storage medium having stored one or more software programs to be executed by an information processing apparatus and being readable by said information processing apparatus,
said information processing apparatus having a storage unit for storing a plurality of correspondence information items between parameter values and condition information for representing an applicable condition of said parameter values, and
said program causing said information processing apparatus to read from said storage unit said parameter values obtained by a test of a produced software program and corresponded with condition information that meets performance information for representing performance of said program, and
function as operation processing means producing said parameter values and parameter configuration information used for defining identification information of said produced software program.

7. An information processing apparatus for managing one or more programs, comprising:
a storage unit storing identification information of said software, parameter configuration information used for defining parameter values used by said software, and said software;
a communication unit through which said information processing apparatus is connected with a network; and
operation processing means reading, from said storage unit, said software program and parameter configuration information having identification information of said software program and outputting and transferring, from said communication unit, said software program and said parameter configuration information to another information processing apparatus located on said network.

8. An information processing apparatus according to claim 7, further comprising:
a display unit displaying said parameter values included in said parameter configuration information; and
an edition accepting unit accepting an edition of said parameter values displayed on said display unit,
wherein said operation processing means operates to change said parameter values included in said parameter configuration information on the basis of said edition accepted by said edition accepting unit.

9. A storage medium having stored one or more software programs to be executed by an information processing apparatus for managing software and being readable by said information processing apparatus, comprising:
said information processing apparatus having a storage unit for storing identification information of said software and parameter configuration information used for defining parameter values used by said software;
a communication unit through which said information processing apparatus is connected with a network, and
said program causing said information processing apparatus to read from said storage unit said software and parameter configuration information having identification information of said software and to function as operation processing means outputting and transferring, from said communication unit, said software and said parameter configuration information to another information processing apparatus located on said network.

10. A storage medium according to claim 9, wherein said information processing apparatus includes a display unit and an input accepting unit, and said program causes said operation processing means to display on said display unit said parameter values included in parameter configuration information stored in said storage unit and, when said input accepting unit accepts an edition of said parameter values displayed on said display unit, to change said parameter values included in said parameter configuration information stored in said storage unit based on said edition accepted by said input accepting unit.

11. An information processing apparatus for starting software, comprising:
a communication unit receiving through a network said software and parameter configuration information from another information processing apparatus having a storage unit having stored said parameter configuration information in which identification information of said software and parameter values used by said software are defined, and said software itself; and
operation processing means starting said software with the parameter values included in said parameter configuration information as parameter values to be delivered to said software.

12. An information processing apparatus for starting software according to claim 11, wherein another information processing apparatus further comprises:
a display unit displaying said parameter values included in said parameter configuration information;
an edition accepting unit for accepting an edition of said parameter values displayed on said display unit; and
operation processing means changing said parameter values included in said parameter configuration information, based on an edition accepted by said edition accepting unit.

13. An information processing system comprising:
a first information processing apparatus developing software; and
a second information processing apparatus managing said software developed by said first information processing apparatus,
wherein said first information processing apparatus comprises:
a first storage unit storing said software;
an input accepting unit accepting inputs of identification of said software and parameter values used when said software is started;
first operation processing means generating parameter configuration information in which said identification information accepted by said input accepting unit and said parameter values are defined;
a first communication unit transferring said software and said parameter configuration information to said second information processing apparatus, and
wherein said second information processing apparatus comprises:
a second communication unit receiving said software and said parameter configuration information from said first information processing apparatus;
a second storage unit storing said software and said parameter configuration information received by said second communication unit; and
second operation processing means reading said software and said parameter configuration information having identification information of said software from said second storage unit, outputting and transferring said software and said parameter configuration information from said communication unit to a third information processing apparatus for starting said software with the parameter values included in said parameter configuration information.

14. An information processing system comprising:
a first information processing apparatus testing a developed software; and
a second information processing apparatus managing said software tested by said first information processing apparatus,
wherein said first information processing apparatus comprises:
a first storage unit for storing correspondence information between parameter values and condition information for representing an applicable condition of said parameter values, and said software;
operation processing means reading said parameter values obtained by said test and corresponded with condition information that fulfills performance information for representing performance of said software from said first storage unit and generating parameter configuration information in which said parameter values and identification information of said software are defined; and
a first communication unit transmitting said software and said parameter configuration information to said second information processing apparatus, and
wherein said second information processing apparatus comprises:
a second communication unit receiving said software and said parameter configuration information from said first information processing apparatus;
a second storage unit storing said software and said parameter configuration information received by said second communication unit; and
second operation processing means reading said software and said parameter configuration information having identification information of said software from said second storage unit, outputting and transferring said software and said parameter configuration information from said communication unit to a third information processing apparatus for starting said software with parameter values included in said parameter configuration information.
